(19) United States
(12) Patent Application Publication
(10) Pub. No.: US 2026/0189276 A1
(43) Pub. Date: Jul. 2, 2026

(54) SPOOFING ATTACK DETECTION IN WIRELESS NETWORK

(71) Applicants: George Mason University, Fairfax, VA (US); Emory University, Atlanta, GA (US)

(72) Inventors: Kai Zeng, Fairfax, VA (US); Ya Jiang, Fairfax, VA (US); Liang Zhao, Atlanta, GA (US)

(73) Assignees: George Mason University, Fairfax, VA (US); Emory University, Atlanta, GA (US)

(21) Appl. No.: 18/591,555

(22) Filed: Feb. 29, 2024

Related U.S. Application Data
(60) Provisional application No. 63/499,729, filed on May 3, 2023.

(51) Int. Cl. H04B 7/06; H04B 17/318

(52) U.S. Cl. CPC H04B 7/0617; H04B 17/318

(57) ABSTRACT

An apparatus for spoofing attack detection in a wireless system and a method of operation thereof. The apparatus includes a multi-antenna RF array, a beamformer, a preprocessor and a machine learning-based detector. The array produces signals in response to an RF signal from a transmitter having one or more transmitter beam patterns. The beamformer combines the signals using a receiver beam pattern to produce a received signal. The preprocessor produces feature vectors of an RF fingerprint, where a component of a feature vector is a strength of the received signal for a measured beam pattern pair, the beam pattern pair having a transmitter beam pattern and a receiver beam pattern, or a designated value for an unmeasured beam pattern pair. The detector is configured to detect a spoofing attack from an incomplete feature vector that has at least one component corresponding to an unmeasured beam pattern pair.

### RELATED APPLICATIONS

This application claims the benefit of provisional application Ser. No. 63/499,729 filed May 3, 2023 and titled “Spoofing Attack Detection in 5G Network,” the entire content of which is hereby incorporated by reference.

### GOVERNMENT RIGHTS

This invention was made with government support under grant number W911NF-21-1-0187 awarded by the United Stated Army Research Laboratory. The government has certain rights in the invention.

### BACKGROUND

Due to the broadcast nature of wireless medium, a wireless network, such as a 5G or nextG wireless network, is subject to the identity spoofing attacks in which the attacker impersonates a legitimate user by changing its identity, e.g., medium access control (MAC) or IP address into that of a legitimate user. Radio Frequency (RF) fingerprinting is found to be transmitter and location-specific, and thus a promising alternative for identity spoofing attack detection or transmitter authentication. From that perspective, spoofing attack detection can be formulated as a classification problem based on machine learning using some physical-layer information such as signal-to-noise-ratio (SNR), which is location-specific due to path loss and channel fading.

However, to reduce the beam sweeping overhead, efficient beam sweeping schemes only evaluate a subset of beam patterns, so that only SNR traces with missing features would be obtained, and the missing patterns could be random according to different settings and scenarios. It is infeasible to train a machine learning-based detector for all the possible missing patterns, since this is exponential to the number of all the beam patterns. In addition, online detection would be impaired if features with missing patterns were used.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 illustrates measurement of signal-to-noise ratio (SNR) traces during a beam pattern sweeping process for a wireless communication network, in accordance with various representative embodiments.

FIG. 2 illustrates the collection of SNR traces during an efficient beam pattern sweeping operation, in accordance with various representative embodiments.

FIG. 3 shows a spoofing attack detector, in accordance with various representative embodiments.

FIG. 4 is a flow chart of a method training for a spoofing attack detector, in accordance with various representative embodiments.

FIG. 5 is a block diagram showing components of a wireless network, in accordance with various representative embodiments.

FIG. 6 is a flow chart of a method of missing feature learning, in accordance with various representative embodiments.

FIG. 7 is a graph demonstrating the efficiency of a spoofing attack detector, in accordance with various representative embodiments.

FIG. 8 is a graph comparing receiver operating characteristic (ROC) curves of models, in accordance with various representative embodiments.

FIGS. 9(a)-9(h) show the detection performance of models trained on data with different sample sizes and missing ratios of baseline features, in accordance with various representative embodiments.

### DETAILED DESCRIPTION

The various apparatus and devices described herein provide machine learning-based mechanisms for detecting spoofing attacks in a wireless network.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

An embodiment of the disclosure includes an apparatus for detecting spoof attacks in a wireless system. The apparatus includes a multi-antenna radio frequency (RF) array, a beamformer, preprocessor and a machine learning-based detector. The multi-antenna radio frequency (RF) array is configured to produce a plurality of signals in response to an RF signal from a transmitter having one or more transmitter beam patterns. The beamformer is configured to combine the plurality of signals produced by the multi-antenna array in accordance with one or more receiver beam patterns to produce a received signal. The preprocessor is configured to produce an RF fingerprint including one or more feature vectors, where a component of a feature vector is a strength of the received signal for a measured beam pattern pair, the beam pattern pair having a transmitter beam pattern and a receiver beam pattern or a designated value (such as zero) for an unmeasured beam pattern pair. The machine learning-based detector is configured to detect a spoofing attack from an incomplete feature vector, where an incomplete feature vector has at least one component corresponding to an unmeasured beam pattern pair.

The strength of the received signal may be a received signal strength (RSS), a signal-to-noise-ratio (SNR) of the received signal, or some other measure.

In one implementation, the machine learning-based detector is configured to detect a spoof attack when a sigmoid function of a weighted sum of components of the feature vector is below a threshold value. The detector may be trained using multi-task learning, in which complete feature vectors are used in a main task and incomplete feature vectors are used in auxiliary tasks, where a complete feature vector has no component corresponding to an unmeasured beam pattern pair. The machine learning-based detector may be trained using an alternating direction method of multipliers (ADMM), as described below.

An updater may be used to update the machine learning-based detector incrementally, in real-time, using one or more incomplete feature vectors.

The preprocessor may be configured to decode a transmitter beam pattern index from the received signal, the transmitter beam pattern index associated with a component position in a feature vector.

In one embodiment, the transmitter is a transceiver of a transmitter device, and the multi-antenna radio frequency (RF) array is configured to transmit a signal to the transceiver that triggers a full or partial sweep of transmitter beam patterns by the transmitter device.

In addition to detecting a spoof attack, the apparatus may be configured to detect a location or identify of the transmitter from the RF fingerprint.

The apparatus may be included in an access point or base station for a wireless network or in user equipment for the wireless network. The user equipment may be a mobile device.

A method of detecting spoof attacks in a wireless network is also disclosed. The method processes a set of measured beam pattern pairs, each beam pattern pair having a transmitter beam pattern and a receiver beam pattern by combining signals from a multi-antenna radio frequency (RF) array of a receiver in accordance with the receiver beam pattern of a beam pattern pair to produce a receiver signal. The signals are produced in response to an RF signal from a transmitter utilizing the transmitter beam pattern of the beam pattern pair. The strength of the received signal for the beam pattern pair is measured and used to generate an RF fingerprint including one or more feature vectors. A component of a feature vector is the strength of the received signal for a measured beam pattern pair or a designated value (such as zero) for an unmeasured beam pattern pair. A machine learning-based detector is then used to detect a spoofing attack from an incomplete feature vector, where an incomplete feature vector has at least one component corresponding to an unmeasured beam pattern pair. In one embodiment, the spoofing attack is detected by determining when a sigmoid function of a weighted sum of components of the feature vector is below a threshold value.

A transmitter beam pattern index may be decoded from the received signal and associated with a component position in a feature vector.

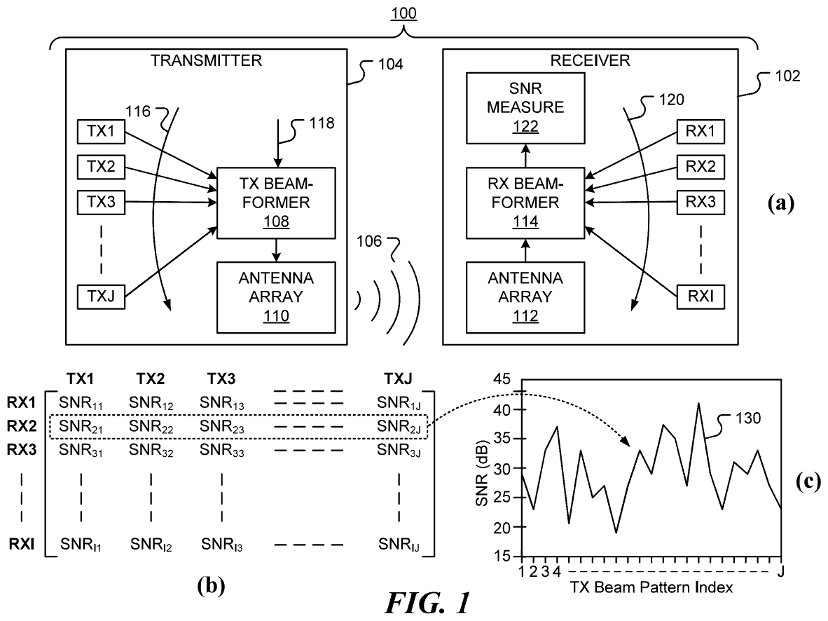

FIG. 1 illustrates how signal-to-noise ratio (SNR) traces can be measured during a beam pattern sweeping process for a wireless communication network such as a 5G network operating in the millimeter wave (mmWave) band or IEEE 802.11ad network.

FIG. 1(a), shows two parties of a system 100: receiver 102 and transmitter 104. These may be user equipment of a client and access point (AP) or base station, for example, or vice versa. Both user equipment and AP or base station may have both transmitter (TX) and receiver (RX) capabilities. Receiver 102 and transmitter 104 communicate over wireless channel 106. Transmitter 104 has beam forming capabilities using transmitter (TX) beamformer 108 and multi-antenna RF array 110. The transmitter is pre-coded with certain numbers of beam patterns denoted as TX1, TX2, . . . , TXJ. Similarly, receiver 102 includes multi-antenna RF array 112 and beamformer 114. To obtain a highest signal quality for a pair of stations, they follow a sector level sweeping (SLS) or initial access (IA) process to identify the best TX-RX beam pairs. Transmitter 104 sweeps through beam patterns as indicated by arrow 116, sending a signal 118 with each beam pattern. Receiver 102 sweeps through beam patterns as indicated by arrow 120, measuring the signal-to-noise ratio (SNR) for each TX-RX pair in circuit 112. FIG. 1(b), shows measured the SNR with different transmitter and receiver beam pattern indexes. Signal level SNRᵢⱼ denotes the signal strength for transmitter beam pattern TXi and receiver beam pattern RXj. These levels are used as a fingerprint to differentiate a legitimate user from an attacker. Therefore, the beam pattern indexes that constitute the feature vector of an SNR trace refer to the signals at different transmitter and receiver indexes. FIG. 1(c) shows an example SNR trace 130 for receiver beam pattern RX2.

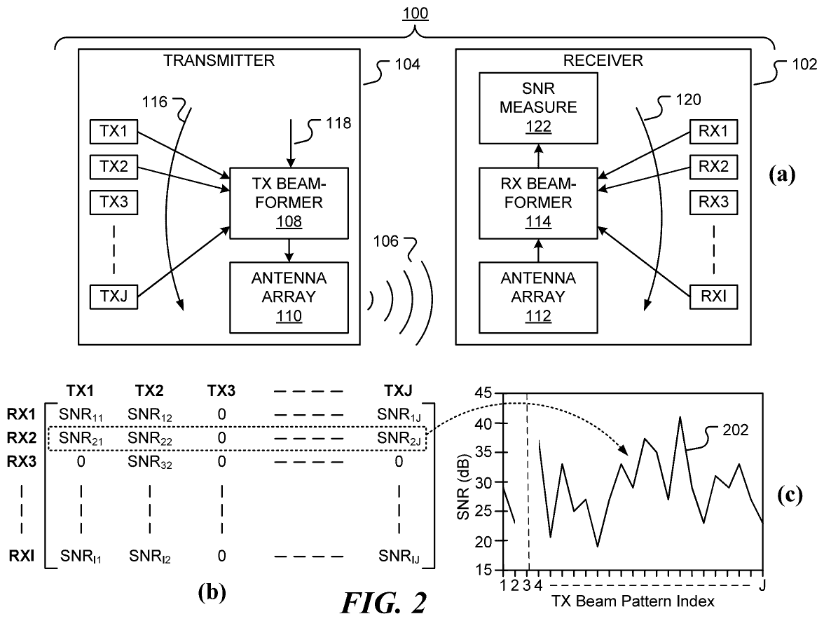

FIG. 2 illustrates the collection of SNR traces during an efficient beam pattern sweeping operation. The resulting SNR traces have missing features corresponding to the beam patterns not measured. FIG. 2(a) shows an efficient beam pattern sweeping scheme in which only a subset of the beam patterns are measured. In the example shown, at least transmitter pattern TX3 and receiver pattern RX3 or omitted. FIG. 2(b) shows the results SNR measurements. Missing SNR measurement are shown as zero. Thus, all of the components of the row for RX3 and the column for TX3 are shown as zero. FIG. 2(c) shows the corresponding SNR trace 202 for RX3. The SNR for TX3 is missing. In general, it is not known in advance which components will be missing. Missing patterns could be random according to different settings and environments.

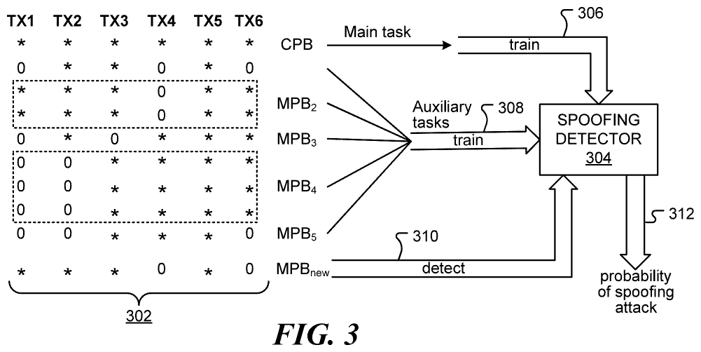

FIG. 3 shows a spoofing attack detector, in accordance with various representative embodiments of the disclosure. The example shown focuses on transmitter-specific characteristics, so the receiver sector is fixed. Thus, the measured SNR traces are multi-dimensional vectors corresponding to the number of transmitter indexes. Each row of SNR measurements in table 302 correspond to SNRs measured for a sweep through eight transmitter beam patterns, TX1-TX8. Row CPB is a complete pattern block, since all 8 TX patterns were measured. As indicated by zero values in table 202, the remaining measured SNR traces miss features for random TX beam patterns.

Machine learning-based is used to train spoofing attack detector 304 in the presence of missing features. The data is first divided into different missing pattern blocks (MPBs) according to their shared missing features. That is, in the simple example shown in FIG. 3, blocks CPM, MPB₁, MPB₂, MPB₃, MPB₄, and MPB₅ are constructed, then, a multi-task learning approach is used for feature selection. The complete block CPB is used as the main task, as indicated by arrow 306 and the data with missing features are used as auxiliary tasks, as indicated by arrow 308. These auxiliary tasks may be treated as noises for improving the generalization of the model. Finally, an alternating direction method of multipliers (ADMM) computation is used to optimize a detector sigmoid function and thereby train a highly accurate detection model with small samples.

As indicated by arrow 310, when a new SNR trace arrives, a missing pattern block MPB_{new} is constructed and fed into detector 304 to produce signal 312 indicating whether the new block was generated during normal beam pattern sweeping or during the process of spoofing attack.

The broadcast characteristic of a wireless medium makes it vulnerable to spoofing attacks. Moreover, spoofing attacks could be launched, with low cost, simply by changing the identity, e.g., medium access control (MAC) or IP address, into that of a legitimate user. In that case, spoofing attacks could cause considerable damage to wireless communication caused by exponentially increasing connectivity among IoT devices. Conventional authentication mechanisms to verify device identities are based on upper layer protocols that may be too complex and resource-restrictive for use on many edge users. Such techniques tend to be cryptographically-based and require active collaboration, hence involving computational resources, power drain, and may still not be able to meet latency requirements. In contrast, RF fingerprinting for spoofing attack detection using physical layer features eliminate the need for cryptography and the associated overhead, as all electronic devices have fingerprints and radio frequency emitters due to manufacturing variability. To further reduce communication overhead, efficient beam pattern sweeping schemes are exploited, during which only the subset of beam patterns would be probed and thus measured SNR traces would miss several features. That is, some dimensions may not have a value. In that case, for existing powerful machine learning-based methods which usually requires the same dimensions of feature vectors for training and detection, the training process and online prediction would be significantly impacted. To make matters worse, the missing patterns would be random when identifying the best TX-RX pairs during the beam forming process. Therefore, how to trade off the communication overhead and detection flexibility is a notable problem.

The disclosed machine learning-based detector enables spoofing attack detection under randomly missing features with high accuracy and low training overhead. It allows efficient spoofing attacks detection in wireless communication with that utilize efficient beam pattern sweeping schemes. In practice, the detector can be deployed in different scenarios, such as Autonomous Vehicles and Unmanned Aerial Vehicles, which support massive user connections through wireless medium and also have stringent requirements on communication overhead and security. Moreover, the detector has the potential to exploit other types of physical-layer features, such as channel state indicator (CSI) and received signal strength (RSS). These may also be prone to missing features caused by instability of wireless communication.

In 5G wireless communication, millimeter-Wave (mmWave) technology unlocks the ultra-wide bandwidth opportunity in supporting applications that require high-throughput (e.g., multi-Gbps) and ultra-low latency, such as autonomous driving and virtual reality (VR), at much lower cost-per-bit. However, due to the broadcast nature of wireless medium, mmWave communication is still subject to various attacks, such as identity spoofing attacks, in which the attacker impersonates a legitimate user by changing its identity, e.g., medium access control (MAC) or IP address into that of a legitimate user. This type of attack is usually the first step towards advanced attacks, such as man-in-the-middle attacks and denial-of-service attacks [14, 15, 8]. The cryptography-based authentication scheme fails to thwart identity spoofing attacks while handling an insider attacker with the compromised authentication key. Furthermore, some control or management frames may not be protected by cryptography means, and thus are vulnerable to identity spoofing attacks.

RF fingerprinting is usually transmitter and location-specific due to transmitter hardware impairment and location-dependent channel state. For mmWave communication, existing beam pattern-based RF fingerprinting mechanisms [10, 11, 12] detect the identity spoofing attack using a unique RF fingerprint, such as the received signal strength (RSS) or signal-to-noise-ratio (SNR) traces of beam patterns obtained in the sector level sweep (SLS) process. In that case, RF fingerprint is a promising alternative to counter the above identity spoofing attacks, even when the attacker is co-located with the legitimate user.

However, existing beam pattern-based fingerprinting simply assumes that an exhaustive beam sweeping is conducted so that the SNRs of all the TX-RX beam pattern pairs are collected. In practice, an exhaustive search in beam sweeping introduces great overhead. Therefore, to reduce beam sweeping overhead, the efficient beam-sweeping and management schemes are proposed [2, 3], which only probe a subset of TX-RX pattern pairs by leaving the SNRs of the remaining beam patterns unobserved, and thus would collect incomplete SNR traces with missing values. Therefore, if the machine learning model is trained with the complete SNR traces, it may not achieve a desirable detection performance when only incomplete SNR traces are available for online prediction. On the other hand, it is not feasible to train all the possible missing patterns, which is exponential to the number of all the beam patterns. In that case, a new machine learning model that can tackle missing features with low training overhead is in great need.

To tackle the challenges brought by randomly missing features, instead of simply abandoning them, the disclosed spoofing attack detector takes advantage of data with missing features to achieve fast and accurate spoofing attack detection in mmWave networks.

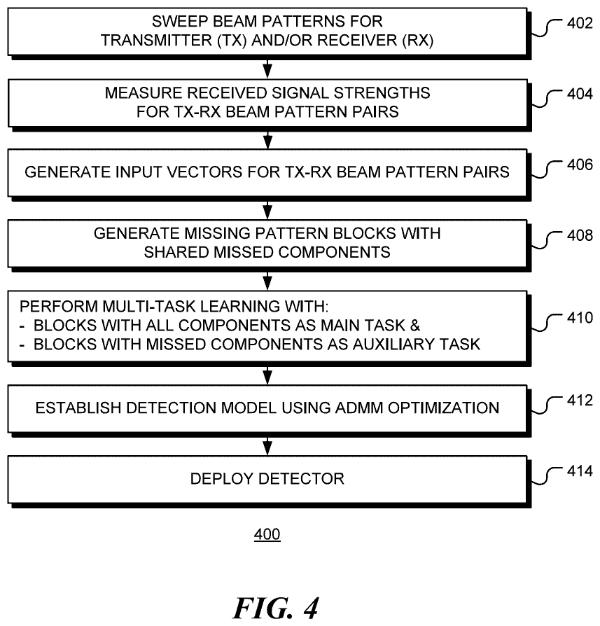

FIG. 4 is a flow chart of a method 400 of training for a spoofing attack detector, in accordance with various representative embodiments. At block 402, a sweep of beam patterns is performed for one or more receiver beam patterns and one or more transmitter beam patterns. At block 404, the strengths of the received signals (e.g., RSS or SNR) are measured for each TX-RX beam pattern pair. At block 406, feature vectors are generated from the strength measurements, with zero or some other designated value used for missing components. At block 408, the feature vectors are divided into different blocks according to their shared missing features and missing pattern blocks are constructed. At block 410, multi-task learning is used to train the detector, treating complete vectors as the main task and incomplete vectors (vectors with missing features) as auxiliary tasks. An alternating direction method of multipliers (ADMM) approach [4] is used at block 412 to establish a detection model. High accuracy may be achieved with relatively few sample blocks. Finally, at block 414, the detector is deployed in a receiver in. for example, a wireless access point or client device of a wireless network.

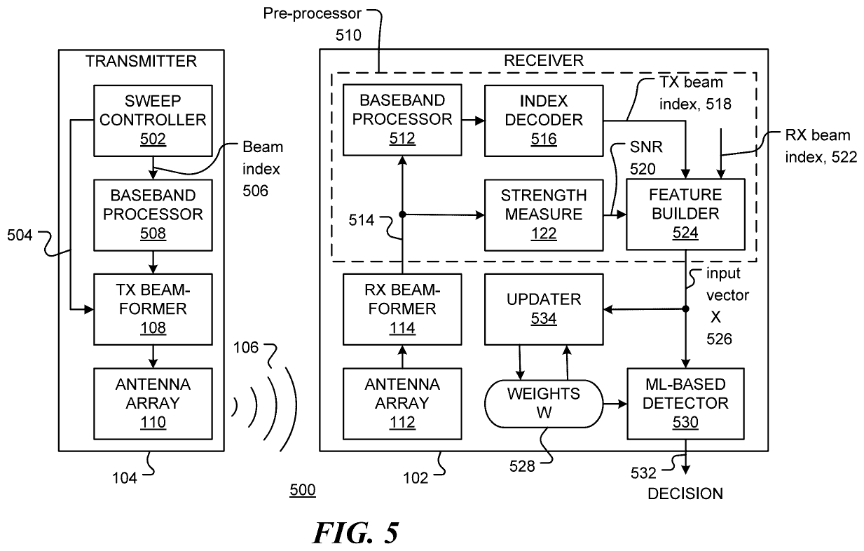

FIG. 5 is a block diagram showing components of a wireless network 500, in accordance with various representative embodiments. Wireless network 500 includes receiver 102 and transmitter 104. These may be a client and access point (AP), for example, and both may have transmitter (TX) and receiver (RX) capabilities. Receiver 102 and transmitter 104 communicate over wireless channel 106. Transmitter 104 has beam forming capabilities using transmitter (TX) beamformer 108 and multi-antenna RF array 110. The transmitter is pre-coded with certain numbers of beam patterns, selection of which is controlled by sweep controller 502 and pattern selection signal 504. Sweep controller may generate a signal 506 that indicates the index of the selected TX beam. A sweep may be performed during a sector level sweep (SLS) or an initial access (IA) process to identify the best TX-RX beam pairs. Alternatively, a sweep may be triggered in response to a request from the transmitter of the receiver. Baseband processor 508 may be used to generate a transmission signal including a TX beam pattern index. Similarly, receiver 102 includes multi-antenna RF array 112 and beamformer 114. pattern. Receiver 102 includes pre-processor circuit 510 which includes a baseband processor 512 to convert received RF signal 514 to a baseband signal, decoder 516 to recover the index 518 of the TX beam pattern, and measurement circuit 122 to measure the strength 520 of received RF signal 514. TX beam index 518, strength measure 520 and RX beam index 522 are input to feature builder 524 that generates feature vector X (526). Feature vector 526 and model weights 528 are used by spoofing attack detector 530 to produce output signal 532 indicative of whether or not the feature vector is the result of a spoofing attack. Updater circuit 534 is used to update model weights 528 based on new feature vectors 526.

Previous spoofing attack detectors do not handle SLS SNR traces containing the missing features for mmWave RF fingerprinting. The ability of the disclosed detector to handle SLS SNR traces containing the missing features greatly reduces the requirement on quality of data and enables information these traces to be utilized.

The disclosed detector enables a globally optimal solution to the learned model by introducing auxiliary variables and training the models using an alternating direction method of multipliers (ADMM) approach. This also enables incremental updates to the model.

In example experiments on the open-source dataset collected from the off-the-shelf 802.11ad devices, the disclosed detector achieves high efficiency with the accuracy of almost 100% and construction time of less than 0.3 ms. Moreover, when performing co-located attack detection, the performances (i.e., accuracy, precision, recall, F1 score) are improved by over 18%, compared to the model trained on data consisting of only complete features.

In general, there are two types of RF fingerprinting for identity spoofing attack detection or transmitter authentication: channel-based ones and hardware-based ones. For channel-based fingerprinting, physical-layer information used for channel/location-based identify spoofing attack detection is usually location-specific due to path loss and channel fading, such as SNR, RSS, or channel state information (CSI) [9, 14, 15, 10, 12]. Therefore, an identity-spoofing attacker at a different location from the legitimate user can be detected with different CSI, RSS, or SNR observed by the access point (AP) or base station (BS). However, co-located spoofing attacks with very similar location features to legitimate user's cannot be detected by these methods. To achieve an efficient spoofing attack detection using off-the-shelf devices and tackle co-located attackers simultaneously, Wang et al. [10, 11, 12]propose to use the SLS SNR traces that are found to be both transmitter and channel-dependent, as the RF fingerprint to detect spoofing attackers in IEEE 802.11ad mmWave networks. However, the SNR traces in this work are obtained under complete beam sweeping processes, where all the TX-RX beam pattern pairs are probed. In practice, in order to reduce the beam sweeping overhead, many proposed efficient beam sweeping and management schemes [2, 3] only test a subset of beam patterns, so that only SNR traces with missing features would be obtained, and the missing patterns could be random according to different communication settings and scenarios. In that case, SNR traces with missing values will affect the training process of machine learning-based models as well as online prediction, whereas it has not been well studied.

By contrast, with fingerprints that are dependent on the hardware impairments instead of the channel, hardware-based approaches can tackle co-located attackers and provide a unique fingerprint to recognize an individual device. However, most existing hardware-based fingerprinting schemes require a high-end analyzer or software-defined radio device to extract high-precision physical layer signal features, implying extra hardware deployment overhead or higher hardware requirements and thus can be hardly implemented by off-the-shelf devices.

### Feature Selection for Missing Values

Feature selection is extremely significant to prediction performance and computational efficiency in machine learning tasks. Therefore, attention is paid to the key features that most impact performance indicators (e.g., accuracy, precision, recall, F1-score). Moreover, to achieve a highly-efficient prediction, features may be re-weighted so that the features that are relatively not as important and make their weights the least. For example, to achieve fast UAV identification over encrypted Wi-Fi traffic, Alipour-Fanid et al. [1] propose to extract features only from packet size and inter-arrival time of encrypted Wi-Fi traffic and adopt a re-weighted l1-norm regularization. They consider the number of samples and computation cost of different features, jointly optimizing feature selection and prediction performance in a unified objective function.

On the other hand, learning the missing features is becoming another focus in the real world. A common solution is imputing certain substitute values for the missing data (e.g., mean) [7]. However, they are not as sensitive as learning-based features to the different devices in some scenarios [11], especially when a significant amount of features are missing. Furthermore, mean imputation does not take information related to both class and missing features into account [6]. To address that problem, Hernandez et al. [5] utilize probabilistic matrix factorization, yet restricted to non-random missing values. In that case, Yuan et al. [13] utilize multi-task learning to learn a consistent feature selection pattern across different missing groups. They model multiple tasks and build them upon a shared representation, in which the learning rate is enhanced by the parallel learning, thus reducing network overfitting, and improving the generalization effect. However, they cannot incrementally update the model in real-time, and thus have to retrain the whole model to adapt to the new-coming missing values.

### System Model and Problem Description

By way of example, a mmWave communication network (e.g., 5G network operating at the mmWave band or IEEE 802.11ad network) is considered, which includes three parties: access point (AP), legitimate user/client, and attacker. All parties have beamforming capabilities. The AP and client are pre-coded with certain numbers of TX and RX beam patterns. They will follow an SLS or initial access (IA) process to identify the best TX-RX beam pairs, during which the SNR traces, measured by AP with different transmitter and receiver beam pattern indexes, would be used as a fingerprint to differentiate a legitimate user from an attacker. In the example embodiments described herein, the SNR traces are collected with a fixed receiver sector index [11]. Therefore, the beam pattern indexes that constitute the feature vector of an SNR trace refer to the signals at different transmitter indexes. Since it has 36 default transmitting sectors (beam patterns) with a fixed semi-omnidirectional RX beam, the feature vector has 36 components.

Commonly, efficient beam-sweeping and management schemes are applied for finding the optimal beam pair at the AP and client, so that not all TX-RX beam pairs are probed during the SLS or IA procedures. This scheme results in incomplete SNR traces because there is no guarantee that every dimension of the feature vector always has a value.

Attack model: It is assumed that the attacker can impersonate the legitimate user by modifying its own identity into the legitimate user's. The attacker can manipulate arbitrary fields in a frame, such as source and destination IP/MAC addresses, and may even have compromised the authentication key or password of the legitimate user. Furthermore, the attacker can launch the attack at any time and any location, even very close to the victim.

Challenges: Due to the adoption of efficient beam sweeping and management schemes, not all the TX-RX beam pairs may be probed during the SLS or IA procedures. That is, SNR traces will have missing features, which could be random under different environments, settings, and channel conditions, and thus bring challenges for machine learning model training as well as online prediction. The randomly missing features have to be tackled in order to achieve a desirable detection performance.

Beam Pattern Fingerprinting with Missing Features

### Missing Pattern Block.

To describe the proposed model for missing features, a missing pattern block (MPB) is introduced. An MPB is a block of SNR traces that share the same missing features. Assuming that the total number of MPBs is M, thus, Wₘ is defined as the weight matrix learned by m^{th} MPB. Specifically, the missing values in the raw data are filled with 0, and the weight vectors

$${\{ {W}_{m} \}}_{m = 1}^{M}$$

have the same feature dimension as that of the complete training sample.
Feature Learning with Missing Features.

With MPBs, the feature learning problem is formulated as:

$${min}_{W} \{ {L}_{M} ( W ) + {\sum }_{m = 1}^{M} {λ}_{m} {‖ {W}_{m} ‖}_{F} \} , \qquad ( 1 )$$

where W is

$${\{ {W}_{m} \}}_{m = 1}^{M}$$

and the loss function L_{M}(W) is defined as follows:

$${L}_{M} ( W ) = - {\sum }_{m = 1}^{M} \frac{1}{{N}_{m}} \{ {Y}_{m} \cdot log ( h ( {W}_{m} \cdot {X}_{m} ) ) + ( 1 - {Y}_{m} ) \cdot log ( 1 - h ( {W}_{m} \cdot {X}_{m} ) ) \} . \qquad ( 2 )$$

in which Xₘ represents the samples of SLS SNR, and Yₘ is the label indicating if these are spoofing SLS SNRs, while h(⋅) represents a sigmoid function. Particularly,

$${\sum }_{m}^{M} {λ}_{m} {‖ {W}_{m} ‖}_{F}$$

is the regularization term that encodes task-relatedness. ∥⋅∥_{F} is the Frobenius norm, and λₘ is a regularization parameter that achieves a trade-off between loss functions and Wₘ.

To achieve the incremental update, assuming that there are M′ possible new-incoming MPBs, we denote the weight matrices of any unseen MPBs as

$${W}_{m}^{′} ∈ {⋃}_{m = M + 1}^{M + {M}^{′}} {W}_{m} ,$$

respectively. Then the objective function including the unseen missing patterns should be:

$${min}_{W , {W}^{′}} \{ {L}_{M} ( W ) + {\sum }_{m = 1}^{M + {M}^{′}} {λ}_{m} {‖ {W}_{m} ⋃ {W}_{m}^{′} ‖}_{F} \} \qquad ( 3 )$$

where there is no

$${W}_{m}^{′}$$

in the loss function because the newly-incoming trace is unseen in historical data. Here, equation (3) could be prohibitively more time-consuming to be solved than equation (1) because M′ may be very large. It can be shown that the equations (1) and (3) are equivalent. This enables the proposed model to be updated online.

It can be shown, by contradiction, that solution to the variables W′ is all-zeros. Specifically, assume there exist solution W and W″ to the objective function value such that W″≠0. Then there must be a corresponding solution W and W′ such that W′≠0 which will achieve an even lower objective function value because

$${\sum }_{m = 1}^{M} {λ}_{m} {‖ {W}_{m} ⋃ 0 ‖}_{F} \leq {\sum }_{m = 1}^{M} {λ}_{m} {‖ {W}_{m} ⋃ {W}^{″} ‖}_{F} .$$

Then it is easy to see that

$${W}^{′} = 0 and {\sum }_{m = 1}^{M} {λ}_{m} {‖ {W}_{m} ⋃ 0 ‖}_{F} = {\sum }_{m = 1}^{M} {λ}_{m} {‖ {W}_{m} ‖}_{F} .$$

The above proof indicates that the variables involved in equation (3) are the active set among all variables in equation (1). Here, the active set means the key solution typically consists of non-zero feature weights while, in equation (3), all the remaining feature weights outside the active set are trivially zeros [16]. The equivalence shows an efficient way where only the small problem on the active set needs to be solved, and thus new-incoming missing patterns could be incrementally updated instead of training the model from scratch using all the MPBs.

Moreover, the objective function in the equation (1) is convex with the optimal weight tensor for two reasons: 1) the Hessian matrix is semi-definite, and 2) the Frobenius norm is convex. To avoid possible vanishing gradients caused by the Frobenius norm and sigmoid function, the process of parameters optimization is performed utilizing an ADMM framework. Therefore, equation (1) can be reformulated as follows.

$${min}_{W} \{ {L}_{M} ( W ) + {\sum }_{m = 1}^{M} {λ}_{m} {‖ {Φ}_{m} ‖}_{F} \} s . t . {W}_{m} - {Φ}_{m} = 0 , m = 1 , 2 , … , M \qquad ( 4 )$$

From equation (1) the augmented Lagrangian function can be obtained as:

$$loss ( {W}_{m} , {Φ}_{m} , {Γ}_{m} ) = {L}_{M} ( W ) + {\sum }_{m = 1}^{M} {λ}_{m} {‖ {Φ}_{m} ‖}_{F} \} + {\sum }_{m = 1}^{M} tr ( {Γ}_{m} ( {W}_{m} - {Φ}_{m} ) ) + \frac{ρ}{2} {\sum }_{m = 1}^{M} {λ}_{m} {‖ {W}_{m} - {Φ}_{m} ‖}_{F}^{2} \qquad ( 5 )$$

where Γₘ is the Lagrangian multiplier and ρ is the penalty parameter.

To solve the objective function in equation (5) with multiple unknown parameters Wₘ, Φₘ, and Γₘ, an ADMM approach is used to update these parameters until convergence as follows, where k represents kₜₕ updating process.

1. Update Wₘ

The weight matrix Wₘ can be learned utilizing second-order Taylor expansion as follows.

$$\begin{matrix}{W}_{m}^{k + 1} = arg {min}_{{W}_{m}} loss ( {W}_{m} , {Φ}_{m}^{k} , {Γ}_{m}^{k} ) \\ = arg {min}_{{W}_{m}} ( {L}_{M} ( W ) + \frac{ρ}{2} {‖ {W}_{m} - {Φ}_{m}^{k} + \frac{1}{ρ} {Γ}_{m}^{k} ‖}_{F}^{2} )\end{matrix} \qquad ( 6 )$$

2. Update Φₘ

With a proximal operator, Φₘ can be efficiently updated utilizing the soft-thresholding method.

$$\begin{matrix}{Φ}_{m}^{k + 1} = arg {min}_{{Φ}_{m}} loss ( {W}_{m}^{k + 1} , {Φ}_{m} , {Γ}_{m}^{k} ) \\ = arg {min}_{{Φ}_{m}} ( {λ}_{m} {‖ {Φ}_{m} ‖}_{F} + \frac{ρ}{2} {‖ {W}_{m}^{k + 1} - {Φ}_{m} + \frac{1}{ρ} {Φ}_{m}^{k} ‖}_{F}^{2} )\end{matrix} \qquad ( 7 )$$

3. Update Γₘ

The Lagrangian multiplier is updated as follows.

$${Γ}_{m}^{k + 1} = {Γ}_{m}^{k} + ρ ( {W}_{m}^{k + 1} - {Φ}_{m}^{k + 1} ) \qquad ( 8 )$$

Specifically, the missing features learning is demonstrated as Method 1, where the calculation of dual and primal residual refers to [4], and ρ is the penalty parameter. After obtaining

$${\{ {W}_{m} \}}_{m = 1}^{M}$$

for all M MPBs, to integrate these learning weights into a final representation, we take Wₘ with the contribution ratio of their corresponding blocks during the training process and add all of them up. Therefore, the final representation of feature weights is as follows, where ratioₘ represents the contribution ratio of their corresponding blocks during the training process.

$$W = {\sum }_{m = 1}^{M} ( {W}_{m} * {ratio}_{m} ) \qquad ( 9 )$$

In that case, during the detection phase, W could be used by the sigmoid function for binary classification.

```
  Method 1: Missing features learning
$Input : {\{ {X}_{m} \}}_{m}^{M} , {\{ {Y}_{m} \}}_{m}^{M} , {\{ {λ}_{m} \}}_{m}^{M} , epochs$
Output: final representation Wₒₚₜᵢₘₐₗ
$initialize ρ , {\{ {W}_{m} \}}_{m}^{M} , {\{ {Γ}_{m} \}}_{m}^{M} , {\{ {Φ}_{m} \}}_{m}^{M} , ε = 1 {0}^{- 4}$
for k = 1 to epochs do
  for m = 1 to M do
    ${W}_{m}^{k + 1} ← Equation ( 6 )$
    ${Φ}_{m}^{k + 1} ← Equation ( 7 )$
    ${Γ}_{m}^{k + 1} ← Equation ( 8 )$
  end
  $r = ρ {\sum }_{m}^{M} \text{\vert \vert} {Φ}_{m}^{k + 1} - {Φ}_{m}^{k} {\text{\vert \vert}}_{F} \# calculate dual residual$
  $s = {\sum }_{m}^{M} \text{\vert \vert} {W}_{m}^{k + 1} - {Φ}_{m}^{k + 1} {\text{\vert \vert}}_{F} \# calculate primal residual$
  update ρ until r < ε^{s} and s < ε^{r}:
  if r > 10 × s then
    ρ ← 2ρ
  else
    if 10 × r < s then
        $ρ ← \frac{ρ}{2}$
      else
        ρ ← ρ
      end
    end
end
Wₒₚₜᵢₘₐₗ ← Equation (9)
```

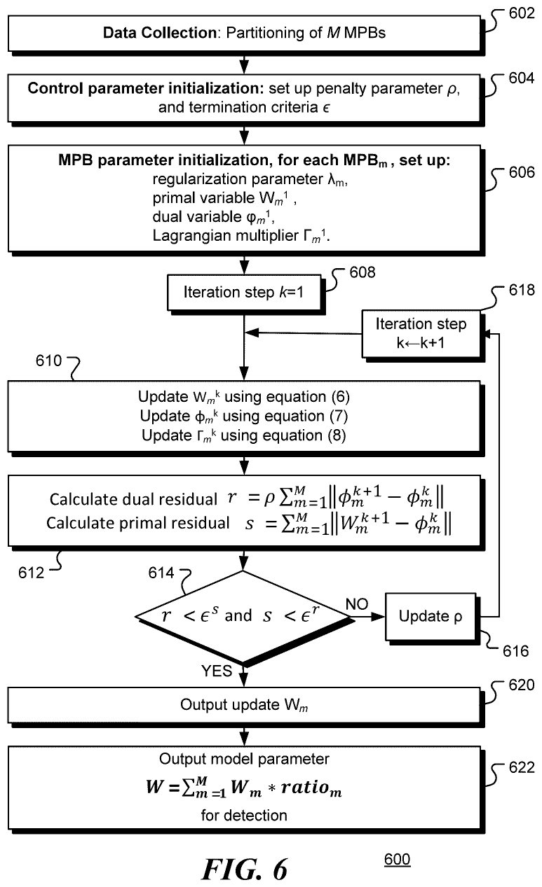

FIG. 6 is a flow chart of a method 600 of missing feature learning, in accordance with various representative embodiments. The method follows Method 1, described above. Referring to FIG. 6, measured feature vectors are partitioned into missing pattern blocks (MPBs) at block 602. Penalty parameters ρ and termination criterion ε are initialized at block 604. MPB parameters are initialized at block 606, including regularization parameters {λₘ}, primal variables

$$\{ {W}_{m}^{1} \} ,$$

dual parameters

$$\{ {Φ}_{m}^{1} \} ,$$

and Lagrangian multipliers

$$\{ {Γ}_{m}^{1} \} .$$

An iteration process begins at block 608. At block 610, primal variables

$$\{ {W}_{m}^{1} \} ,$$

dual parameters

$$\{ {Φ}_{m}^{1} \} ,$$

and Lagrangian multipliers

$$\{ {Γ}_{m}^{1} \}$$

are update in accordance with equations (6), (7) and (8), respectively. Dual and primary residuals are determined at bock 612. At decision block 614, it is determined whether the termination criteria have been met. If not, as depicted by the negative branch from decision block 614, the penalty parameter ρ is update at block 616. The iteration count is updated at block 618 and flow returns to block 610 for another iteration. When the termination criteria have been met, as depicted by the positive branch from decision block 614, the primal variables Wₘ are output at block 620. At block 622 the model parameters (weights W) are computed, as a weighted sum of the primal variables Wₘ, and output for detection.

### Generation of Training Data

For the binary classification problem relevant to spoofing attack detection, it is relatively easy to obtain positive training data directly from the legitimate user. However, historical SNR traces of attackers are not available due to their sensitivity to location and orientation. Therefore, for negative training samples, a generative adversarial network (GAN) may be utilized, which is more suitable for negative data generation. Particularly, negative samples generation is initialized simultaneously with the collection of SLS SNR traces. In that case, these negative samples could diversify the training data and improve the discriminative power of the model, thus quickly constructing the classifier with small samples.

Specifically, GAN consists of a generator and a discriminator, where the generator could generate the fake samples and the discriminator is responsible for discerning the real samples and fabricated ones. Because the goal is to make the discriminator unable to distinguish whether the sample is real or comes from the output of the generator, the sample discriminant probability is ½. Therefore, the loss function of mₜₕ block is as follows.

$${min}_{G} {max}_{D} V ( D , G ) = - \frac{1}{2} {𝔼}_{x ∼ {p}_{x}} log ( D ( x ) ) - \frac{1}{2} {𝔼}_{z ∼ {p}_{z}} log ( 1 - D ( G ( z ) ) ) \qquad ( 10 )$$

where V(⋅) denotes the difference between discriminator and generator, and x˜pₓ represents x is subject to the distribution of normal samples, and z˜p_{z} means z is subject to the distribution of noise in the generator. Therefore, the equation (10) expresses the difference of real samples from the generated ones.

### Evaluation

### Dataset Source and Generation

To evaluate the performance of proposed detection approach that is capable of detecting spoofing attacks under missing features, the open-source SLS SNR dataset [11] is utilized (collected from the Talon AD7200 routers under the settings of the same orientation, 36 default transmitting sectors and a fixed receiving sector) and randomly discarded features. The data used is outlined in TABLE 1, in which A1L1 represents the traces of one AD7200 router at location 1, and A2L1 is the data collected by the other AD7200 router at location 1. Therefore, generated by different AD7200 devices at the same locations, these SLS SNR traces can also be used to validate the effectiveness in detecting co-located attacks. In addition, Python script is used to evaluate the collected measurement data on macOS with 32G memory and a 2 GHz 4-core Intel Core i5 CPU.

TABLE 1
The statistics of data used for evaluation.

| | Number of SNR traces | Number of features |
|---|---|---|
| A1L1 | 3,308 | 36 |
| A2L1 | 3,800 | 36 |

### Small Samples Training

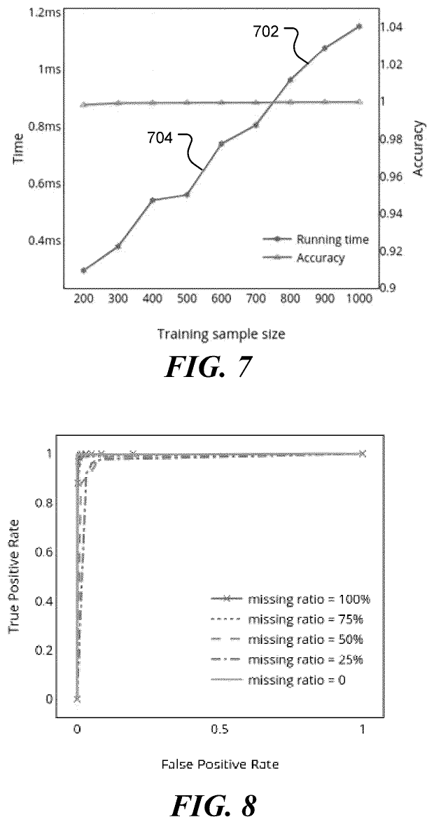

FIG. 7 demonstrates the efficiency of the model, including the running time 702 for constructing the detection model and the performance accuracy 704 of detecting spoofing attacks. Here, half features with greater weights are first selected by training the detection model with 200 samples and test the model on 5,000 samples, both of which have complete features. The normal traces are from A1L1 data, and the attack traces are generated by GAN, in which the positive and negative data has the same ratio. Achieving a high accuracy of almost 100%, this experiment provides us the half amount of features (1, 2, 5, 6, 7, 8, 11, 12, 16, 18, 21, 23, 26, 27, 32, 33, 34, 35) that have greater weights, in which every index represents a sweeping direction. To show the efficiency of the proposed method in detecting spoofing attacks, both training and test data only contain traces with incomplete features. Therefore, 5 types of subset ((1, 11), (2, 8, 12, 26, 27), (5, 32, 35), (6, 16, 18, 33), (7, 21, 23, 34)) are randomly discarded from the half amount of features with the same ratio to construct the training dataset, and 10 types of subset ((1), (2), (11, 26), (12, 27), (5, 16, 32), (6), (7, 21, 34), (8, 35), (23), (18, 33)) with the same ratio for the test dataset. From FIG. 7, it can be seen that the training time is linearly increasing with the sample size. However, they all achieve high accuracy of almost 100%, even with the extremely small sample size. Therefore, it can be effectively applied in spoofing attack detection with SLS SNR traces that requires high-level timeliness and accuracy.

### Co-Located Attacks Detection Performance

In this experiment, one AD7200 router at location 1 is designated as the legitimate user and the other AD7200 router at the same location as the co-located attacker. Therefore, A1L1 is regarded as the traces of legitimate user and A2L1 contains the traces of co-located attacker.

TABLE 2
Detection performance of model trained and tested
on 200 and 5,000 full set, respectively.

| Accuracy | Precision | Recall | F1 Score |
|---|---|---|---|
| 0.99360 | 0.99321 | 0.99400 | 0.99360 |

TABLE 2 shows the performance of the model both trained and tested on data with all features. From that experiment, the half amount of features with greater weights are selected as the baseline features. Therefore, the indexes of 18 baseline features are (2, 4, 8, 10, 11, 12, 13, 15, 18, 23, 24, 26, 27, 29, 30, 31, 33, 36). Next, the robustness of the proposed approach is demonstrated by testing its performance on the data missing all these baseline features.

FIG. 8 compares the receiver operating characteristic (ROC) curve of models on test data with different ratios of traces that miss features. Here, the training sample size and test sample size are 1,000 and 5,000, respectively, where one half of training samples miss all baseline features and the other half have complete features. It can be seen that the disclosed detector can handle all these scenarios of different missing ratios with high effectiveness and robustness, where the classifier achieves better performance on test data with 100% missing ratio and 0 missing ratio.

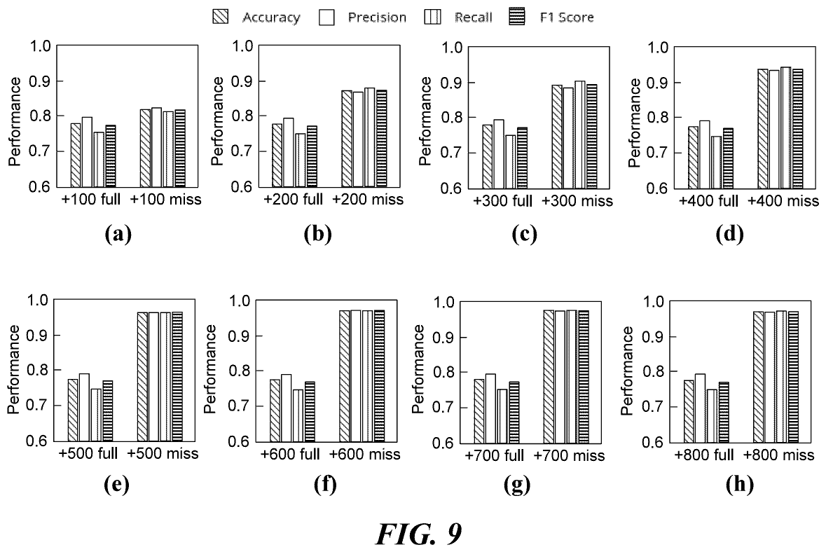

FIGS. 9(a)-9(h) show the detection performance of models trained on data with different sample sizes and missing ratios of baseline features and tested on 5,000 samples where all baseline features are missed. Initially, the training sample contains all features and has a size of 200. Then samples were added with the size ranging from 100 to 800, which miss all baseline features to the initial training samples, to construct the dataset containing both intact and incomplete features. Moreover, to compare its performance with the model trained on data containing only full features, several samples were added containing only intact features with the size ranging from 100 to 800 to the initial training samples (shown in FIGS. 9(a)-9(h) respectively). From these drawings, it can be seen that the proposed approach achieves a higher detection performance utilizing the information provided by traces that are missing several features. Therefore, taking good advantage of incomplete traces is significantly helpful, because it is not necessarily to train a highly-accurate detection model only on data with full features. Moreover, it reduces the requirement on data quality, which is especially effective and robust for the common scenario where beam pattern sweeping does not always probe all sectors.

The machine learning-based model may be trained with SLS SNR traces that contain missing features. To further satisfy the requirements of real-time detection with high performance, GAN is introduced to achieve small sample learning. The proposed model is robust under the co-located attacks, where the experiments show that the performance can be improved by 18% compared to the model trained on data containing only complete features.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations conducted can often be varied, additional operations can be added, or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

### REFERENCES

[1] Amir Alipour-Fanid, Monireh Dabaghchian, Ning Wang, Pu Wang, Liang Zhao, and Kai Zeng. 2020. Machine Learning-Based Delay-Aware UAV Detection and Operation Mode Identification Over Encrypted Wi-Fi Traffic. IEEE Transactions on Information Forensics and Security (2020).
[2] Irmak Aykin, Berk Akgun, and Marwan Krunz. 2019. Smartlink: Exploiting Channel Clustering Effects for Reliable Millimeter Wave Communications. In IEEE Conference on Computer Communications (INFOCOM).
[3] Irmak Aykin and Marwan Krunz. 2020. Efficient Beam Sweeping Algorithms and Initial Access Protocols for Millimeter-Wave Networks. IEEE Transactions on Wireless Communications (2020).
[4] Stephen Boyd, Neal Parikh, Eric Chu, Borja Peleato, and Jonathan Eckstein. 2011. Distributed Optimization and Statistical Learning via the Alternating Direction Method of Multipliers. Found. Trends Mach. Learn. 3, 1 (2011), 1-122.
[5] José Miguel Hernindez-Lobato, Neil Houlsby, and Zoubin Ghahramani. 2014. Probabilistic Matrix Factorization with Non-Random Missing Data. In Proceedings of the 31st International Conference on International Conference on Machine Learning.
[6] Pasha Khosravi, Yitao Liang, YooJung Choi, and Guy Van den Broeck. 2019. What to expect of classifiers?reasoning about logistic regression with missing features. arXiv preprint arXiv:1903.01620 (2019).
[7] Roderick J A Little and Donald B Rubin. 2019. Statistical analysis with missing data. Vol. 793. John Wiley & Sons.
[8] Jie Tang, HongWen, Kai Zeng, and Run-fa et al. Liao. 2019. Light-weight physical layer enhanced security schemes for 5G wireless networks. IEEE Network (2019).
[9] Ning Wang, Long Jiao, Pu Wang, Monireh Dabaghchian, and Kai Zeng. 2018. Efficient Identity Spoofing Attack Detection for IOT in mm-wave and Massive MIMO 5G Communication. In IEEE Global Communications Conference (GLOBECOM).
[10] Ning Wang, Long Jiao, Pu Wang, Weiwei Li, and Kai Zeng. 2020. Machine Learning-based Spoofing Attack Detection in MmWave 60 GHz IEEE 802.1 lad Networks. In IEEE Conference on Computer Communications (INFOCOM).
[11] Ning Wang, Long Jiao, Pu Wang, Weiwei Li, and Kai Zeng. 2021. Exploiting Beam Features for Spoofing Attack Detection in mmWave 60-GHz IEEE 802.11ad Networks. IEEE Transactions on Wireless Communications (2021).
[12] Ning Wang, Weiwei Li, Long Jiao, Amir Alipour-Fanid, Tao Xiang, and Kai Zeng. 2021. Orientation and Channel Independent RF Fingerprinting for 5G IEEE 802.1 lad Devices. IEEE Internet of Things Journal (2021).
[13] Lei Yuan, Yalin Wang, Paul M. Thompson, Vaibhav A. Narayan, and Jieping Ye. 2012. Multi-source feature learning for joint analysis of incomplete multiple heterogeneous neuroimaging data. Neurolmage 61 (2012), 622-632.
[14] Kai Zeng, Kannan Govindan, and Prasant Mohapatra. 2010. Non-cryptographic authentication and identification in wireless networks [security and privacy in emerging wireless networks]. IEEE Wireless Communications (2010).
[15] Kai Zeng, Kannan Govindan, Daniel Wu, and Prasant Mohapatra. 2011. Identity-based attack detection in mobile wireless networks. In IEEE Conference on Computer Communications (INFOCOM).
[16] Liang Zhao, Yuyang Gao, and Jieping et al. Ye. 2021. Spatio-Temporal Event Forecasting Using Incremental Multi-Source Feature Learning. ACM Trans. Knowl. Discov. Data (2021).

What is claimed is:

1. An apparatus comprising:
a multi-antenna radio frequency (RF) array configured to produce a plurality of signals in response to an RF signal from a transmitter having one or more transmitter beam patterns;
a beamformer configured to combine the plurality of signals produced by the multi-antenna array in accordance with one or more receiver beam patterns to produce a received signal;
a preprocessor configured to produce an RF fingerprint including one or more feature vectors, where a component of a feature vector is:
a strength of the received signal for a measured beam pattern pair, the beam pattern pair having a transmitter beam pattern and a receiver beam pattern;
a designated value for an unmeasured beam pattern pair;
a machine learning-based detector configured to detect a spoofing attack from an incomplete feature vector, where an incomplete feature vector has at least one component corresponding to an unmeasured beam pattern pair.

2. The apparatus of claim 1, where the strength of the received signal is a received signal strength (RSS) or a signal-to-noise-ratio (SNR) of the received signal.

3. The apparatus of claim 1, where the machine learning-based detector is configured to detect a spoof attack when a sigmoid function of a weighted sum of components of the feature vector is below a threshold value.

4. The apparatus of claim 1, where the machine learning-based detector is trained using multi-task learning in which complete feature vectors are used in a main task and incomplete feature vectors are used in auxiliary tasks, where a complete feature vector has no component corresponding to an unmeasured beam pattern pair.

5. The apparatus of claim 1, where the machine learning-based detector is trained using an alternating direction method of multipliers (ADMM).

6. The apparatus of claim 1, further comprising an updater configured to update the machine learning-based detector incrementally, in real-time, using one or more incomplete feature vectors.

7. The apparatus of claim 1, where the preprocessor is configured to decode a transmitter beam pattern index from the received signal, the transmitter beam pattern index associated with a component position in a feature vector.

8. The apparatus of claim 1, where the transmitter is a transceiver of a transmitter device and where the multi-antenna radio frequency (RF) array is further configured to transmit a signal to the transceiver that triggers a sweep of transmitter beam patterns by the transmitter device.

9. The apparatus of claim 1, further configured to detect a location or identity of the transmitter from the RF fingerprint.

10. An access point or base station for a wireless network, the access point or base station including the apparatus of claim 1.

11. User equipment for a wireless network, the user equipment including the apparatus of claim 1.

12. A method comprising:
for a plurality of measured beam pattern pairs, each beam pattern pair having a transmitter beam pattern and a receiver beam pattern:
combining a plurality of signals from a multi-antenna radio frequency (RF) array of a receiver in accordance with the receiver beam pattern of a beam pattern pair to produce a receiver signal, the plurality of signals produced in response to an RF signal from a transmitter utilizing the transmitter beam pattern of the beam pattern pair;
measuring a strength of the received signal for the beam pattern pair;
generating an RF fingerprint including one or more feature vectors, where a component of a feature vector is:
the strength of the received signal for a measured beam pattern pair;
a designated value for an unmeasured beam pattern pair; and
detecting, in a machine learning-based detector, a spoofing attack from an incomplete feature vector, where an incomplete feature vector has at least one component corresponding to an unmeasured beam pattern pair.

13. The method of claim 12, where the strength of the received signal is a received signal strength (RSS) or a signal-to-noise-ratio (SNR) of the received signal.

14. The method of claim 12, where detecting the spoofing attack includes determining when a sigmoid function of a weighted sum of components of the feature vector is below a threshold value.

15. The method of claim 12, further comprising training the machine learning-based detector using multi-task learning in which complete feature vectors are used in a main task and incomplete feature vectors are used in auxiliary tasks, where a complete feature vector has no component corresponding to an unmeasured beam pattern pair.

16. The method of claim 12, further comprising training the machine learning-based detector using an alternating direction method of multipliers (ADMM).

17. The method of claim 12, further comprising updating the machine learning-based detector incrementally, in real-time, using one or more incomplete feature vectors.

18. The method of claim 12, further comprising decoding a transmitter beam pattern index from the received signal, the transmitter beam pattern index associated with a component position in a feature vector.

19. The method of claim 12, where the transmitter is a transceiver of a transmitter device, further comprising:
transmitting signal to the transceiver to trigger a full or partial sweep of transmitter beam patterns by the transmitter device.

20. A non-transitory computer readable medium storing a program of instructions that, when executed on a processor of receiver device, perform a method comprising:
for a plurality of measure beam pattern pairs, each beam pattern pair having a transmitter beam pattern and a receiver beam pattern:
combining a plurality of signals from a multi-antenna radio frequency (RF) array of a receiver in accordance with the receiver beam pattern of a beam pattern pair to produce a receiver signal, the plurality of signals produced in response to an RF signal from a transmitter utilizing the transmitter beam pattern of the beam pattern pair;
measuring a strength of the received signal for the beam pattern pair;
generating an RF fingerprint including one or more feature vectors, where a component of a feature vector is:
the strength of the received signal for a measured beam pattern pair;
a designated value for an unmeasured beam pattern pair; and
detecting, in a machine learning-based detector, a spoofing attack from an incomplete feature vector, where an incomplete feature vector has at least one component corresponding to an unmeasured beam pattern pair.
